(19) United States
(12) Patent Application Publication
(10) Pub. No.: US 2013/0263693 A1
(43) Pub. Date: Oct. 10, 2013

(54) CAM ROLLER

(71) Applicant: KRONES AG, Neutraubling (DE)

(72) Inventor: Thomas Albrecht, Beilngries (DE)

(21) Appl. No.: 13/856,272

(22) Filed: Apr. 3, 2013

(30) Foreign Application Priority Data
Apr. 4, 2012 (DE) 10 2012 102 964.4

(51) Int. Cl. F16H 25/14

(52) U.S. Cl. CPC F16H 25/14
USPC 74/567

(57) ABSTRACT

The present Invention relates to a cam roller (1) for a cam mechanism, a cam control and/or a roller track, comprising a roller bolt (3) and a roller body (2) which is rotatable about the latter and which is guidable on a groove cam of the cam mechanism, the cam control and/or on a roller track, wherein a lubricant carrier (4) retained on the roller bolt (3) is provided for the release of lubricant onto the tread (20) of the roller body (2).

### TECHNICAL FIELD

The present invention relates to a cam roller for a cam mechanism, a cam control and/or a roller track.

### PRIOR ART

For forced control of machine parts in cam mechanisms and/or roller tracks guiding a cam roller in a groove cam of the cam mechanism or of the cam control and/or on a roller track is known.

For example from DE 20 2006 003 975 U1 a screw capper for bottles is known, wherein lifting rods by means of which the bottles are conveyed against a sealing head are controlled via forced control which has a self-contained groove cam having guided rolls therein.

Cam rollers are known which are provided with maintenance-free rolling bearings. These maintenance-free rolling bearings may for example be filled with a solid lubricant compound.

It is not only the bearing between the roller body itself and the roller bolt which must be lubricated but also the contact area between the respective groove cam and the roller track and the roller body, respectively, must be lubricated to allow low-wear operation.

From DE 10 2007 008 330 A1 a cam roller mechanism is known wherein cam rollers are guided on cam tracks and each of the cam tracks are provided with lubrication tracks. Upon crossing the lubrication tracks the cam rollers suitably take up lubricant on their treads.

Such lubrication of the treads of the roller body of a cam roller may however result in contamination of the cam track and cam roller thus reducing applicabilities during use of such cam roller in aseptic processing facilities during bottling of beverages in vacuo or in processing facilities which meet specific requirements for sanitation and purity.

### SUMMARY OF THE INVENTION

Accordingly it is an object of the present invention to provide a cam roller which reduces release of lubricants to the cam track.

This object is solved by a cam roller having the features of claim 1. Advantageous embodiments will become apparent from the dependent claims.

Accordingly the cam roller for a cam mechanism, a cam control and/or a roller track comprises a roller bolt and a roller body which is rotatable about the latter and which is guidable on a groove cam of the cam mechanism, the cam control and/or on a roller track. According to the invention a lubricant carrier retained on the roller bolt for releasing lubricant onto the tread of the roller body is provided.

Since the cam roller has a lubricant carrier which is retained on the roller bolt for releasing lubricant onto the tread of the roller body very small amounts of lubricant may directly be applied onto the tread of the roller body. Since the lubricant carrier is entrained by the groove cam according to the displacement of the roller body, due to arrangement thereof on the roller bolt, separate lubrication tracks on the cam track releasing lubricant to the surrounding area are not required. Instead, the lubricant carrier is constantly located at the same place, where it is required for the efficient application of lubricant onto the tread of the roller body. In this way specific release of lubricant exclusively into areas which are actually in need of the lubricant may be allowed.

Due to reduced release of lubricants to the surrounding area such a cam roller may be used in an aseptic processing facility for bottling beverages. Furthermore such a cam roller is suitable for in vacuo use and in processing facilities imposing more stringent requirements to sanitation and cleanliness.

By entrainment of the lubricant carrier by the roller body a significantly reduced amount of lubricant may be applied onto the roller body, since only half a rotation maximum of the tread must be carried out before the tread will again contact the lubricant carrier. Accordingly the amount of lubricant to be metered onto the tread may be set very low and solely a lubricant amount sufficient for half a rotation or one single contact with the groove cam has to be released.

With state of the art cam rollers which for example are provided with lubricant via the lubrication tracks introduced into the respective groove cams a significantly higher amount of lubricant must be taken up onto the tread in order to bridge the distance to the next lubrication track. In prior art lubrication tracks are solely provided on the respective end points of the groove cam, so that on these lubrication tracks as much lubricant has to be taken up as to be sufficient across the whole distance of the respective groove cam to the next lubrication track.

By way of the present invention the amount of lubricant to be applied onto the tread of the roller body may appropriately and significantly be reduced.

By retaining the lubricant carrier to the roller bolt the lubricant carrier may be carried along with the roller body and may also be arranged concentrically to the roller body. In an especially preferred embodiment the lubricant carrier is mounted in a torsion-proof manner to the roller bolt so that touching, grinding or scraping the groove cam or the roller track, respectively, by the lubricant carrier is excluded and the lubricant carrier actually solely contacts the tread of the roller body. In this way contamination of the surrounding area by the lubricant may still further be reduced.

Preferably the lubricant carrier comprises a solid lubricant-compound preferably in the form of a solid porous matrix structure wherein an amount of lubricant is stored. In an especially preferred embodiment all sides of the lubricant carriers contacting the surrounding area are sealed. Accordingly only one side which directly contacts the tread of the roller body is not sealed. In this way leakage of lubricant into the surrounding area may very effectively be avoided.

In a preferred embodiment an outer cage is retained on the roller bolt wherein the lubricant carrier is accommodated. By way of such a cage the lubricant carrier may reliably be applied to the tread of the roller body. The material of the outer cage may be selected such that it has an appropriate strength. This is independent of the strength of the lubricant carrier which typically comprises a porous material.

Especially preferred a biasing device is provided between the outer cage and the lubricant carrier for biasing the lubricant carrier towards the tread of the roller body. By way of the biasing device a contact pressure of the lubricant carrier onto the tread of the roller body may be accomplished which may also be maintained upon wear of the lubricant carriers.

In order to gain independence of the direction of movement of the cam roller the lubricant carrier is preferably arranged symmetrically in relation to the roller bolt. In this context the lubricant carrier may furthermore have at least two parts which are retained on the roller bolt, preferably by means of two outer cages.

The lubricant carrier and especially preferred the cage and/or the biasing device are preferably provided in an angular range of the roller body leaving a contact range of the tread of the roller body with a cam groove of a cam mechanism or a cam control and/or a contact area with a roller track. In other words the arrangement comprising the lubricant carrier, outer cage and biasing device should be formed such that displacement of the cam roller along the appropriately defined track is allowed without scraping of said components on the track.

### BRIEF DESCRIPTION OF THE FIGURES

Further preferred embodiments and aspects of the present invention are more fully explained by the description below of the figures. The figures show:

FIG. 1 is illustrating a schematic perspective view of a cam roller in an oblique frontal view; and

FIG. 2 is illustrating a schematic perspective view of the cam roller of FIG. 1 in an oblique rear view.

### DETAILED DESCRIPTION OF EXAMPLES OF PREFERRED EMBODIMENTS

Examples of preferred embodiments are described below with the aid of the figures. In the figures, elements which are identical or similar, or have identical effects, are designated with identical reference signs, and repeated description of these elements is in part dispensed with in the description below, in order to avoid redundancy.

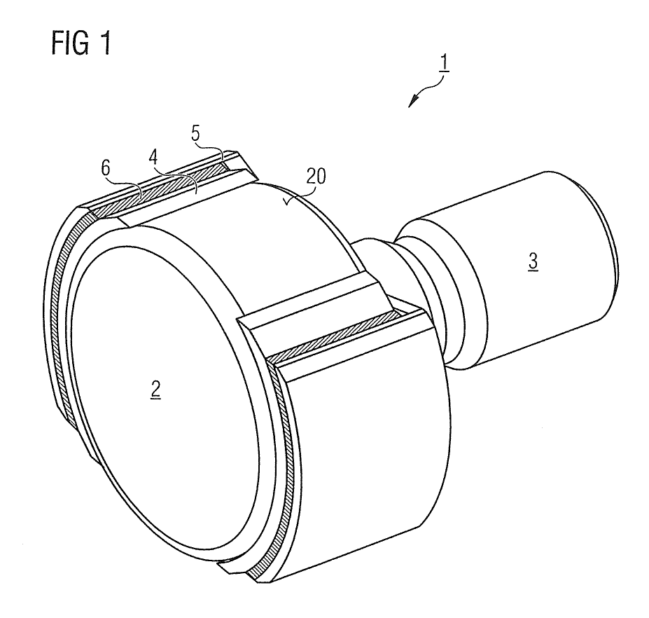

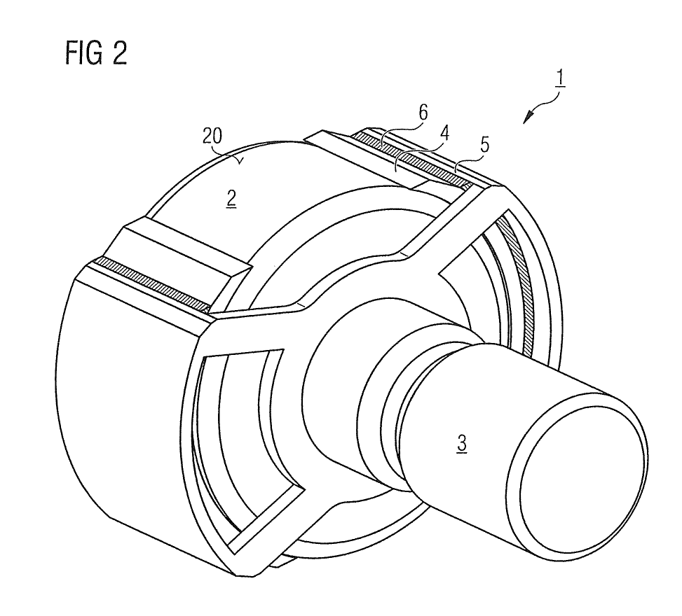

FIGS. 1 and 2 show a cam roller 1 which for example is suitable for a cam mechanism, a cam control or a roller track for forced control of mechanical operations in processing facilities. The cam roller 1 may especially be used in the field of filling and packaging technology of beverages for example in a screw capper for beverage bottles.

The cam roller 1 comprises a roller body 2 which is rotatably supported on a roller bolt 3. The roller body 2 comprises a tread 20 which is in contact with the respective groove track of the cam mechanism or the cam control, or with a roller track. Generally the roller bolt 3 is arranged in the respective machine part which is forcedly controlled by way of cam roller 1 in a torsion-proof manner.

A lubricant carrier 4 for the application of lubricant onto the tread 20 of the roller body 2 is provided, wherein the lubricant carrier 4 is retained on the roller bolt 3. The lubricant carrier 4 will accordingly be entrained by displacement of the cam roller 1.

In the preferred embodiment shown in FIGS. 1 and 2 the lubricant carrier 4 is retained by way of an outer cage 5 on the roller bolt 3. Preferably the exterior cage 5 is retained on the roller bolt 3 in a torsion-proof manner, so that neither the outer cage 5 nor the lubricant carrier 4 will contact or scrape along the respective rolling surface of the groove cam or the roller track, respectively, upon passing the groove cam and the roller track, respectively. Accordingly, the lubricant carrier 4 solely transfers the lubricant to the tread 20 of the roller body 2, but not to other processing facilities. Furthermore, abrasion for example via the outer cage 5 does not occur since the latter does not contact other facility components.

Between the outer cage 5 and the lubricant carrier 4 a biasing device 6 biasing the lubricant carrier 4 towards the tread 20 of the roller body 2 is arranged in the form of a soft elastomer. By the use of the elastomer 6 a full-area and even abutment of the lubricant carrier 4 to the tread 20 of the roller body 2 may be accomplished. In this way, even upon wear of the lubricant carrier 4, satisfactory lubrication of the tread 20 may be accomplished. Instead of the elastomer, for example a leaf spring or equivalent biasing device may be used.

Due to entrainment of the lubricant carrier 4 with the roller body 2 the lubricant carrier 4 may furthermore be set or formed, respectively, such that only a minor amount of lubricant will be applied to the tread 20 since lubricant will be reapplied through the opposite lubricant carrier 4 following half a rotation. Accordingly, by applying only a minor amount of lubricant contamination of the groove cam, the roller track, respectively, and/or other processing facility components may reliably be reduced or even totally avoided, respectively. Thus, the cam roller 1 is also very suitable in aseptic processing facilities, in vacuum processing facilities, as well as in processing facilities having specific requirements for sanitation of processing facilities.

To avoid leakage of lubricant the lubricant carrier 4 is preferably formed such that it is sealed at all outer sides and the sides contacting the surrounding area, respectively. Solely those surfaces directly contacting the tread 20 of the roller body 2 are sealed, so that application of lubricant onto the tread 20 of the roller body 2 may be done.

The lubricant carrier 4 may comprise a solid lubricant-compound which is a solid, porous matrix structure in which a major amount of lubricant is stored. For example a SLC-lubrication may be permitted through the lubricant-compound.

The amount of lubricant stored in the lubricant carrier 4 is thereby to be determined such that it essentially is consistent with the operative life of a rolling bearing for supporting the roller body 2 on the roller bolt 3. Accordingly, in this way a maintenance-free cam roller 1 will be provided, which has to be completely replaced not before the end of its operative life.

The lubricant carrier 4 as well as the outer cage 5 and the elastomer 6 are preferably arranged on opposite sides of the tread 20 of the roller body 2, as it is shown in the figures. Thereby the respective angular range, which is inscribed, is calculated such that by none of the respective components mentioned above scraping on and/or abutting the respective groove cams and roller tracks, respectively, will result.

To the extent applicable, all individual features described in the individual example embodiments can be combined with each other and/or exchanged, without departing from the scope of the invention.

### LIST OF REFERENCE NUMERALS

1 cam roller
2 rotatable roller body
20 tread of the roller body
3 roller bolt
4 lubricant carrier
5 outer cage
6 biasing device

1. A cam roller for a cam mechanism, a cam control and/or a roller track, comprising a roller bolt and a roller body which is rotatable about the latter and which is guidable on a groove cam of the cam mechanism, the cam control and/or on a roller track, characterized by a lubricant carrier retained on the roller bolt for the release of lubricant onto the tread of the roller body.

2. The cam roller according to claim 1, characterized in that the lubricant carrier is retained on the roller bolt in a torsion-proof manner.

3. The cam roller according to claim 1, characterized in that the lubricant carrier comprises a solid lubricant-compound, preferably in the form of a solid, porous matrix structure in which an amount of lubricant is stored.

4. The cam roller according to claim 1, characterized in that an outer cage is retained on the roller bolt in which the lubricant carrier is accommodated.

5. The cam roller according to claim 4, characterized in that between the outer cage and the lubricant carrier a biasing device is provided in order to bias the lubricant carrier towards the tread of the roller body wherein the biasing device preferably is an elastomer or a leaf spring.

6. The cam roller according to claim 1, characterized in that the lubricant carrier is arranged symmetrically to the roller bolt.

7. The cam roller according to claim 1, characterized in that the lubricant carrier is arranged concentrically to the roller bolt.

8. The cam roller according to claim 1, characterized in that the lubricant carrier comprises at least two parts which are retained on the roller bolt, preferably by way of two outer cages.

9. The cam roller according to claim 1, characterized in that the lubricant carrier is provided in an angular range of the roller body leaving a contact area of the tread of the roller body with a cam groove of a cam mechanism or a cam control and/or a contact area with a roller track.

10. The cam roller according to claim 1, characterized in that the lubricant carrier is sealed at all sides contacting the surrounding area.
